(19) United States
(12) Patent Application Publication
(10) Pub. No.: US 2026/0072399 A1
(43) Pub. Date: Mar. 12, 2026

(54) IMAGE FORMING APPARATUS

(71) Applicant: KYOCERA Document Solutions Inc., Osaka (JP)

(72) Inventors: Yuji Toyota, Osaka (JP); Takahisa Nakaue, Osaka (JP)

(21) Appl. No.: 19/316,615

(22) Filed: Sep. 2, 2025

(30) Foreign Application Priority Data
Sep. 9, 2024 (JP) 2024-154680

(51) Int. Cl. G03G 21/20; G03G 15/00; G03G 15/09

(52) U.S. Cl. CPC G03G 21/206; G03G 15/0907; G03G 15/5037; G03G 15/5045; G03G 2215/0609

(57) ABSTRACT

An image forming apparatus according to the present disclosure includes: an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier; a current detection portion configured to detect a target current that flows between the first carrier and the second carrier during development; a temperature detection portion configured to detect a temperature inside the apparatus; and a cooling control portion configured to execute a predetermined cooling operation based on a detected current that is detected by the current detection portion and a detected temperature that is detected by the temperature detection portion.

### INCORPORATION BY REFERENCE

This application is based upon and claims the benefit of priority from the corresponding Japanese Patent Application No. 2024-154680 filed on Sep. 9, 2024, the entire contents of which are incorporated herein by reference.

The present disclosure relates to an electrophotographic image forming apparatus.

### BACKGROUND

An electrophotographic image forming apparatus that forms an image using a two-component developer containing toner and carrier is known. As a conventional technique, there is disclosed an image recording apparatus that stops an image forming operation and performs a cooling operation for lowering the temperature inside the apparatus when the temperature detected by a temperature sensor becomes higher than a predetermined temperature, because image quality deteriorates when the temperature inside the apparatus becomes high.

### SUMMARY

An image forming apparatus according to an aspect of the present disclosure comprises: an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier; a current detection portion configured to detect a target current that flows between the first carrier and the second carrier during development; a temperature detection portion configured to detect a temperature inside the apparatus; and a cooling control portion configured to execute a predetermined cooling operation based on a detected current that is detected by the current detection portion and a detected temperature that is detected by the temperature detection portion.

An image forming apparatus according to another aspect of the present disclosure comprises: an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier; a calibration processing portion configured to execute calibration processing for setting a set voltage value of the bias voltage; a temperature detection portion configured to detect a temperature inside the apparatus; and a cooling control portion configured to execute a predetermined cooling operation based on the set voltage value determined by the calibration processing portion and a detected temperature that is detected by the temperature detection portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming apparatus according to an embodiment of the present disclosure.

FIG. 2 shows a configuration of the image forming apparatus according to the embodiment of the present disclosure.

FIG. 3 shows a configuration of an image forming portion of the image forming apparatus according to the embodiment of the present disclosure.

FIG. 4 is an explanatory diagram showing an example of a waveform of a developing bias of the image forming apparatus according to the embodiment of the present disclosure.

FIG. 5 is a flowchart showing a procedure of a first processing example of cooling processing executed by a control portion of the image forming apparatus according to the embodiment of the present disclosure.

FIG. 6 is a flowchart showing a procedure of a second processing example of the cooling processing executed by the control portion of the image forming apparatus according to the embodiment of the present disclosure.

### DETAILED DESCRIPTION

Hereinafter, an embodiment of the present disclosure will be described with reference to the accompanying drawings. The following embodiment is an example of embodying the present disclosure and is not intended to limit the technical scope of the present disclosure.

### [1] Overall Configuration of Image Forming Apparatus

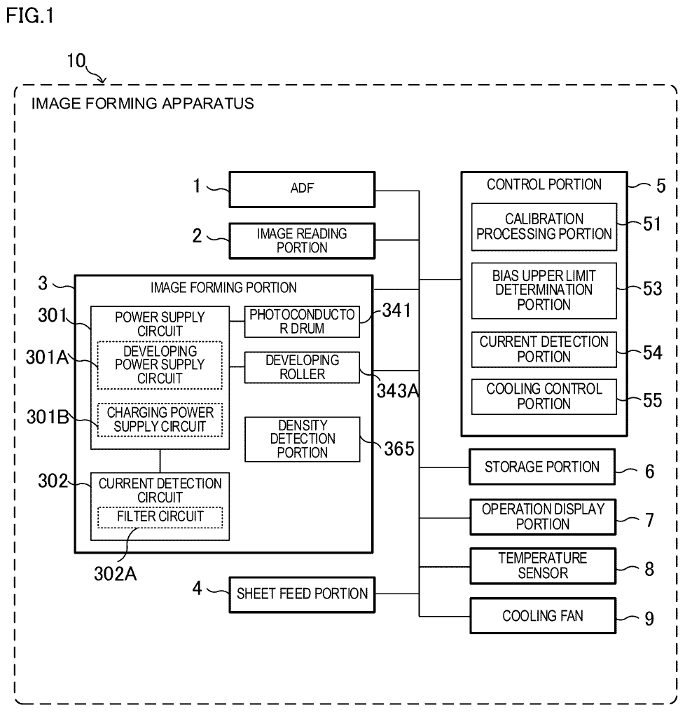

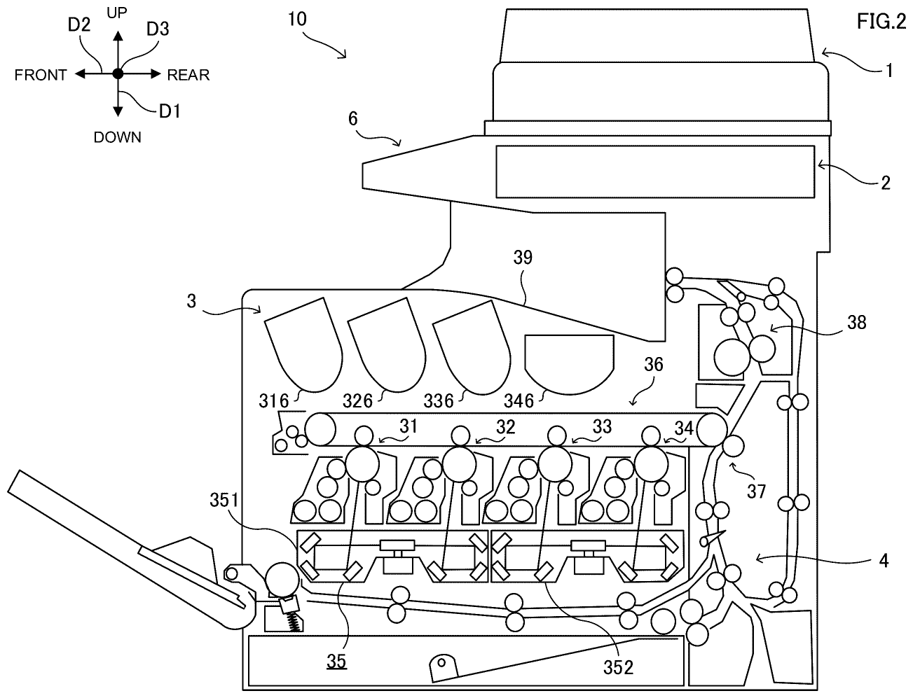

First, a configuration of an image forming apparatus 10 according to the present embodiment will be described with reference to FIG. 1 and FIG. 2.

For convenience of description, the vertical direction in an installation state (the state shown in FIG. 2) in which the image forming apparatus 10 can be used is defined as an up-down direction D1. In addition, a front-rear direction D2 is defined with the left side surface, on the paper surface, of the image forming apparatus 10 shown in FIG. 2 as the front side (front surface). In addition, a left-right direction D3 is defined with reference to the front side of the image forming apparatus 10 in the installation state.

The image forming apparatus 10 according to the present embodiment is a multifunction peripheral having a plurality of functions such as a scanning function for reading image data from a document sheet, a printing function for forming an image based on the image data, a facsimile function, and a copy function. The image forming apparatus 10 may be a printer, a facsimile machine, a copier, or the like as long as it has an image forming function.

As shown in FIG. 1, the image forming apparatus 10 includes an automatic document feeder 1, an image reading portion 2, an image forming portion 3, a sheet feed portion 4, a control portion 5, a storage portion 6, an operation display portion 7, a temperature sensor 8 (an example of the temperature detection portion of the present disclosure), and a cooling fan 9 (an example of the cooling fan of the present disclosure). Since the automatic document feeder 1 is an auto document feeder (ADF), it is indicated as “ADF” in FIG. 1 and is also referred to as an “ADF 1” in the following description.

The ADF 1 conveys a document sheet whose image is read by the image reading portion 2. The ADF 1 includes a document sheet loading portion, a plurality of conveying rollers, a document sheet holder, a sheet discharge portion, and the like.

The image reading portion 2 reads an image from a document sheet and outputs image data corresponding to the read image. The image reading portion 2 includes a document sheet table, a light source, a plurality of mirrors, an optical lens, a charge coupled device (CCD), and the like.

The image forming portion 3 realizes a printing function by forming a color or monochrome image on a sheet based on an electrophotographic method using a two-component developer. The image forming portion 3 forms an image on a sheet based on image data output from the image reading portion 2. In addition, the image forming portion 3 forms an image on a sheet based on image data input from an information processing apparatus, such as a personal computer, external to the image forming apparatus 10.

The sheet feed portion 4 supplies a sheet to the image forming portion 3. The sheet feed portion 4 includes a sheet feed cassette, a manual feed tray, a sheet conveying path, and a plurality of conveying rollers. The image forming portion 3 forms an image on a sheet supplied from the sheet feed portion 4.

The control portion 5 performs overall control of the image forming apparatus 10. The control portion 5 is mainly composed of a computer system including one or more processors and one or more memories. In the image forming apparatus 10, the functions of the control portion 5 are implemented by one or more processors executing programs. The programs may be stored in advance in a memory (storage portion 6), may be provided through a telecommunications line such as the Internet, or may be provided by being stored in a non-transitory recording medium, such as a memory card or an optical disk, readable by the computer system. The one or more processors are composed of one or more electronic circuits, including a semiconductor integrated circuit. Further, the computer system here includes a microcontroller having one or more processors and one or more memories. The control portion 5 may be a control portion provided separately from a main control portion that performs overall control of the image forming apparatus 10.

The storage portion 6 is one or more nonvolatile storage devices. The storage portion 6 is a nonvolatile memory, such as a flash memory or an EEPROM (registered trademark), a solid state drive (SSD), a hard disk drive (HDD), or the like. The storage portion 6 stores in advance information, such as control programs, for causing the control portion 5 to execute various types of processing. Further, the storage portion 6 is used as a temporary storage memory (work area) for various types of processing executed by the control portion 5.

The operation display portion 7 is a user interface in the image forming apparatus 10. The operation display portion 7 includes a display portion, such as a liquid crystal display, for displaying various types of information in response to a control instruction from the control portion 5, and an operation portion, such as a switch or a touch panel, for inputting various types of information to the control portion 5 in response to a user operation.

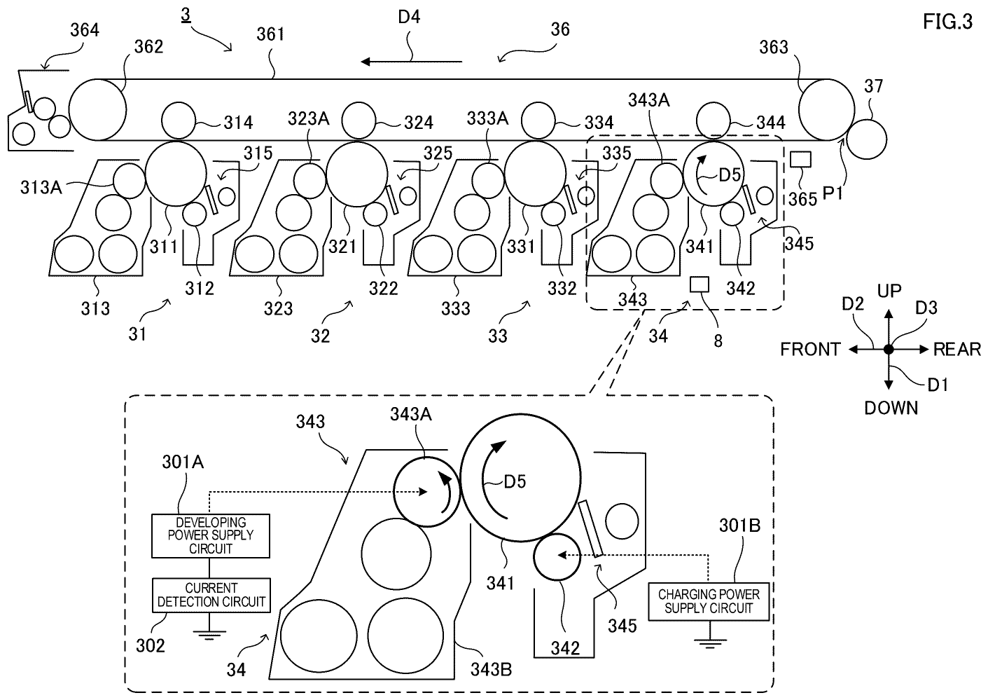

The temperature sensor 8 (see FIG. 3) detects the ambient temperature inside the image forming apparatus 10, and is, for example, a thermistor. The temperature sensor 8 is provided, for example, in the vicinity of the image forming portion 3. In the present embodiment, the temperature sensor 8 is provided in the vicinity of an image forming unit 34 for forming a K (black) toner image, more specifically, in the vicinity of a case 343B of a developing device 343 of the image forming unit 34. In other words, in the image forming portion 3, the temperature sensor 8 is provided in the vicinity of the developing device 343, which holds toner that is most susceptible to the influence of heating during fixing by a fixing device 38 and contains the most consumed toner. The temperature sensor 8 outputs a detection signal corresponding to the magnitude of the detected temperature to the control portion 5.

It is noted that the temperature sensor 8 may be provided corresponding to each of four image forming units 31 to 34 provided in the image forming portion 3.

The cooling fan 9 (see FIG. 3) is a blower for blowing air into the image forming apparatus 10 to lower the internal temperature. The cooling fan 9 is driven and controlled by the control portion 5. The cooling fan 9 is provided, for example, in the vicinity of the image forming unit 34, and is provided, for example, in the vicinity of the case 343B of the developing device 343 of the image forming unit 34.

### [2] Configuration of Image Forming Portion

Next, a configuration of the image forming portion 3 will be described in more detail with reference to FIG. 1 to FIG. 4.

As shown in FIG. 2, the image forming portion 3 includes four image forming units 31 to 34, a laser scanning device 35, an intermediate transfer device 36, a secondary transfer roller 37, a fixing device 38, and a sheet discharge tray 39. FIG. 3 is an enlarged view schematically showing the configuration of one image forming unit 34 of the four image forming units 31 to 34.

Each of the four image forming units 31 to 34 is an example of the image forming portion of the present disclosure. Each of the image forming units 31 to 34 applies a developing bias VB between a photoconductor drum whose surface is charged and a developing roller that holds toner to be adhered to the photoconductor drum to move the toner from the developing roller to a developing area on the photoconductor drum to form a toner image on the photoconductor drum based on the image data.

The image forming unit 31 forms a Y (yellow) toner image. As shown in FIG. 3, the image forming unit 31 includes a photoconductor drum 311 (an example of the first carrier of the present disclosure), a charging roller 312, a developing device 313 including a developing roller 313A (an example of the second carrier of the present disclosure), a primary transfer roller 314, and a drum cleaning portion 315. In addition, the image forming unit 31 further includes a toner container 316 (see FIG. 2).

The image forming unit 32 forms a C (cyan) toner image. As shown in FIG. 3, the image forming unit 32 includes a photoconductor drum 321 (an example of the first carrier of the present disclosure), a charging roller 322, a developing device 323 including a developing roller 323A (an example of the second carrier of the present disclosure), a primary transfer roller 324, and a drum cleaning portion 325. In addition, the image forming unit 32 further includes a toner container 326 (see FIG. 2).

The image forming unit 33 forms an M (magenta) toner image. As shown in FIG. 3, the image forming unit 33 includes a photoconductor drum 331 (an example of the first carrier of the present disclosure), a charging roller 332, a developing device 333 including a developing roller 333A (an example of the second carrier of the present disclosure), a primary transfer roller 334, and a drum cleaning portion 335. In addition, the image forming unit 33 further includes a toner container 336 (see FIG. 2).

The image forming unit 34 forms a K (black) toner image. As shown in FIG. 3, the image forming unit 34 includes a photoconductor drum 341 (an example of the first carrier of the present disclosure), a charging roller 342, a developing device 343 including a developing roller 343A (an example of the second carrier of the present disclosure), a primary transfer roller 344, and a drum cleaning portion 345. In addition, the image forming unit 34 further includes a toner container 346 (see FIG. 2).

In addition, each of the plurality of image forming units 31 to 34 further includes, as shown in FIG. 1, a power supply circuit 301 and a current detection circuit 302 (an example of the current detection portion of the present disclosure) in addition to the above configuration. That is, the power supply circuit 301 and the current detection circuit 302 are provided in each of the plurality of image forming units 31 to 34. Each power supply circuit 301 includes a developing power supply circuit 301A and a charging power supply circuit 301B.

As described above, the plurality of (here, four) image forming units 31 to 34 correspond to four colors of Y (yellow), C (cyan), M (magenta), and K (black), respectively, and basically have a common configuration. Therefore, unless otherwise noted, the configuration described below for the image forming unit 34 is the same for the other image forming units 31 to 33. In the balloon of FIG. 3, only the photoconductor drum 341, the developing roller 343A, the power supply circuit 301, the current detection circuit 302, and the like for the image forming unit 34 are shown.

An electrostatic latent image is formed on the photoconductor drum 341. The photoconductor drum 341 is supported by a unit housing that accommodates the photoconductor drum 341, the charging roller 342, and the drum cleaning portion 345 so as to be rotatable about a rotation axis extending in the left-right direction D3. The photoconductor drum 341 receives drive power supplied from a motor (not shown) and rotates in a rotational direction D5 shown in FIG. 3.

In general, photoconductor drums are classified into an organic photoconductor (OPC), a selenium photoconductor, an amorphous silicon photoconductor, and the like in accordance with the type of the thin film layer on the surface to be charged. In recent years, the amorphous silicon photoconductor, which has high durability and high hardness characteristics and has a long life, have become mainstream for photoconductor drums. In the present embodiment, the photoconductor drum 341 is an amorphous silicon photoconductor drum, which has an amorphous silicon layer on its surface.

In the present embodiment, the charging roller 342 charges the surface (outer peripheral surface) of the photoconductor drum 341 to a positive polarity. Specifically, the charging roller 342 is electrically connected to the charging power supply circuit 301B of the power supply circuit 301, and charges the surface of the photoconductor drum 341 by receiving the application of a high voltage from the charging power supply circuit 301B. However, the charging roller 342 is not limited to those configured to charge the surface of the photoconductor drum 341 to a positive polarity, and may be those configured to charge it to a negative polarity.

The surface of the photoconductor drum 341 charged by the charging roller 342 is irradiated with light based on image data by the laser scanning device 35. Thus, an electrostatic latent image is formed on the surface of the photoconductor drum 341. That is, the potential of the exposed portion of the surface of the photoconductor drum 341 irradiated with light from the laser scanning device 35 becomes lower than the charge potential of the surrounding area (non-exposed area), and the electrostatic latent image is formed. In the present embodiment, the exposed portion is an example of the developing area of the present disclosure, and is an image portion where a toner image is formed. Further, the non-exposed portion which is not exposed is an example of the non-developing area of the present disclosure, and is a portion where a toner image is not formed.

The developing device 343 executes development processing for developing the electrostatic latent image formed on the surface of the photoconductor drum 341. In the present embodiment, in particular, the developing device 343 performs development using a two-component developer containing toner and carrier. For example, the developing device 343 includes a case 343B, a pair of stirring members, a magnet roller, a developing roller 343A, and the like.

The case 343B accommodates a two-component developer containing K (black) toner and carrier. The two-component developer contains, in addition to the toner and the carrier, one or more types of external additives as fluidizing agents for improving the fluidity of the toner. The external additives, such as titanium dioxide particles, are fine particles that are sufficiently smaller in size than the toner to adhere to the surfaces of the toner particles.

The case 343B supports the pair of stirring members, the magnet roller, and the developing roller 343A so as to be rotatable about a rotation axis extending in the left-right direction D3. The pair of stirring members stir the toner and the carrier contained in the case 343B to charge the toner. In the present embodiment, the toner is charged to a positive polarity. However, the charge polarity of the toner is not limited to a positive polarity, and may be a negative polarity. The magnet roller pumps the toner and the carrier stirred by the pair of stirring members, and supplies the toner to the surface (outer peripheral surface) of the developing roller 343A.

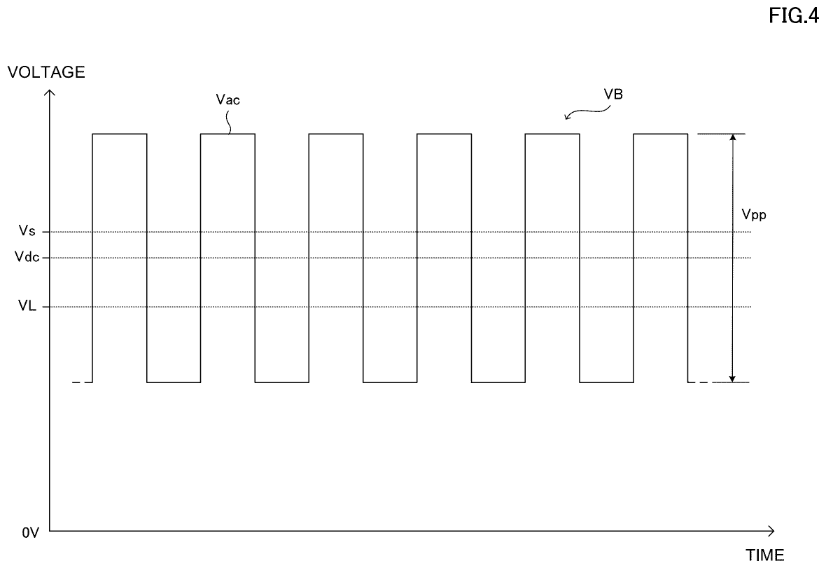

The developing roller 343A develops the electrostatic latent image formed on the exposed portion of the photoconductor drum 341 using the charged toner. Specifically, the developing roller 343A is electrically connected to the developing power supply circuit 301A of the power supply circuit 301, and receives the application of the developing bias VB (see FIG. 4) from the developing power supply circuit 301A, thereby supplying the toner to the surface of the photoconductor drum 341. That is, when a high-voltage developing bias VB is applied between the developing roller 343A and the photoconductor drum 341 by the developing power supply circuit 301A, a developing electric field is formed between the developing roller 343A and the exposed portion, and the charged toner moves from the developing roller 343A to the exposed portion of the photoconductor drum 341. Thus, a toner image corresponding to the electrostatic latent image is formed on the surface of the photoconductor drum 341.

In the present embodiment, the photoconductor drum 341 is an example of the “first carrier”, and the developing roller 343A is an example of the “second carrier”. That is, the image forming portion 3 moves the charged toner from the developing roller 343A to the photoconductor drum 341 by the developing electric field, develops the electrostatic latent image on the photoconductor drum 341 with the toner, and forms a toner image (image) corresponding to the electrostatic latent image on the photoconductor drum 341. That is, in the development processing, the image forming portion 3 moves the charged toner from the second carrier to the first carrier to form a toner image on the first carrier. Here, since the photoconductor drum 341 rotates in the rotational direction D5 (see FIG. 3), the portion on the surface of the photoconductor drum 341 which faces the developing roller 343A changes with time. In other words, the portion on the surface of the photoconductor drum 341 which faces the developing roller 343A moves in the rotational direction D5 of the photoconductor drum 341.

Here, the developing bias VB applied between the developing roller 343A and the photoconductor drum 341 is a voltage in which an AC component Vac is superimposed on a DC component Vdc, as shown in FIG. 4. That is, the developing power supply circuit 301A generates the developing bias VB in which the AC component Vac is superimposed on the DC component Vdc by superimposing the AC voltage on the DC voltage. Therefore, in the development bias VB, a fluctuating component due to the pulsation (ripple) of the AC component Vac is superimposed on the value of the DC component Vdc, and higher and lower values are repeated with respect to the DC component Vdc. In the example of FIG. 4, the AC component Vac of the developing bias VB is a rectangular wave having a duty ratio of 50%, but is not limited thereto, and the AC component Vac may be, for example, a sine wave or a triangular wave.

In the present embodiment, the value (magnitude) of the DC component Vdc in the developing bias VB can be changed. For example, assuming that the surface potential of the photoconductor drum 341 in a charged state is “Vs” and the potential (exposure potential) of the exposed portion of the surface of the photoconductor drum 341 irradiated with light from the laser scanning device 35 is “VL”, the DC component Vdc is set to a value between the surface potential Vs and the exposure potential VL. That is, the value of the DC component Vdc is set to a voltage lower than the surface potential Vs and higher than the exposure potential VL of the exposed portion.

In the present embodiment, the developing bias VB is an example of the “bias voltage” applied between the developing roller 343A and the photoconductor drum 341, and more specifically, the DC component Vdc in the developing bias VB is an example of the bias voltage of the present disclosure.

The primary transfer roller 344 transfers the toner image formed on the surface of the photoconductor drum 341 by the developing device 343 to the outer peripheral surface of the intermediate transfer belt 361 (see FIG. 3). Specifically, the primary transfer roller 344 is electrically connected to the power supply circuit 301, and receives the application of a high voltage from the power supply circuit 301 to transfer the toner image formed on the surface of the photoconductor drum 341 to the outer peripheral surface of the intermediate transfer belt 361. That is, when a high-voltage transfer bias is applied between the photoconductor drum 341 and the primary transfer roller 344 by the power supply circuit 301, a transfer electric field is formed, and the charged toner moves from the photoconductor drum 341 to the intermediate transfer belt 361. Thus, a toner image is formed (transferred) on the outer peripheral surface of the intermediate transfer belt 361.

The drum cleaning portion 345 cleans the surface of the photoconductor drum 341 after the toner image is transferred by the primary transfer roller 344. For example, the drum cleaning portion 345 has a blade-shaped cleaning member and a conveying member. The cleaning member comes into contact with the surface of the photoconductor drum 341 to remove the toner adhering to the surface. The conveying member conveys the toner removed by the cleaning member to the toner container.

The toner container 346 supplies toner to the case 343B of the developing device 343. In the image forming unit 34 for forming the K (black) toner image, the toner container 346 supplies K (black) toner.

In the present embodiment, when the developing bias VB is applied between the developing roller 343A and the photoconductor drum 341, a developing current and a non-developing current due to the DC component Vdc flow between the developing roller 343A and the photoconductor drum 341.

As described above, an electrostatic latent image is formed on the surface of the photoconductor drum 341 by irradiation of the surface with light based on the image data from the laser scanning device 35. The surface of the photoconductor drum 341 includes the exposed portion where the electrostatic latent image is formed and a non-exposed portion where the electrostatic latent image is not formed. The exposed portion is a light irradiation area which is irradiated with light, and is a developing area where a toner image is formed. The non-exposed portion is a non-irradiation area which is not irradiated with light, and is a non-developing area where a toner image is not formed.

A magnet body is disposed inside the developing roller 343A, and the developing roller 343A rotates around the stationary magnet body. One of the magnetic poles of the magnet body faces an opposing area (development gap) where the developing roller 343A and the photoconductor drum 341 face each other with a predetermined gap therebetween. The two-component developer carried by the developing roller 343A forms a magnetic brush in the opposing area.

When the developing bias VB is applied between the developing roller 343A and the photoconductor drum 341, a first electric field for moving the toner from the developing roller 343A toward the exposed portion of the photoconductor drum 341 through the magnetic brush is formed between the developing roller 343A and the exposed portion in the opposing area. In addition, when the developing bias VB is applied between the developing roller 343A and the photoconductor drum 341, a second electric field for moving the toner from the exposed portion toward the developing roller 343A through the magnetic brush is formed between the developing roller 343A and the non-exposed portion in the opposing area. The toner contained in the magnetic brush in the opposing area moves to the exposed portion of the surface of the photoconductor drum 341 by the action of the first electric field and the second electric field formed in the opposing area, and does not move to the non-exposed portion. Thus, the electrostatic latent image formed on the surface of the photoconductor drum 341 is developed (visualized).

It is noted that the developing area to be developed on the photoconductor drum 341 does not have to be the exposed portion but may be the non-exposed portion. In this case, the non-developed area which is not developed may be the exposed portion or may be a non-charged area which is not charged by the charging roller 342. When the developing area where the toner image is developed is the non-exposed portion, the toner is charged to a polarity opposite to the charge polarity of the charged area.

The developing current includes a toner current that flows as toner moves from the developing roller 343A to the exposed portion through the magnetic brush, and a magnetic brush current that flows from the developing roller 343A to the exposed portion through the magnetic brush due to a potential difference between the developing roller 343A and the exposed portion. In the present embodiment, a current that flows from the developing roller 343A to the exposed portion of the photoconductor drum 341 is defined as “positive” (plus).

The non-developing current is a reverse toner current that flows as toner moves from the non-exposed portion to the developing roller 343A through the magnetic brush, and a reverse magnetic brush current that flows from the non-exposed portion to the developing roller 343A through the magnetic brush due to a potential difference between the developing roller 343A and the non-exposed portion. In the present embodiment, a current that flows from the non-exposed portion of the photoconductor drum 341 to the developing roller 343A is defined as “negative” (minus).

The current detection circuit 302 detects the developing current and the non-developing current that flow between the photoconductor drum 341 and the developing roller 343A. The current detection circuit 302 is, for example, a circuit including a current sensor such as a shunt resistor or a current transformer, and is provided on a current path from the power supply circuit 301 to the developing roller 343A. The current detection circuit 302 outputs a detection signal corresponding to the magnitude of the developing current that flows from the developing roller 343A to the exposed portion of the photoconductor drum 341 to the control portion 5. In addition, the current detection circuit 302 outputs a detection signal corresponding to the magnitude of the non-developing current that flows from the non-exposed portion of the photoconductor drum 341 to the developing roller 343A to the control portion 5.

In addition, in the present embodiment, the current detection circuit 302 includes a filter circuit 302A. The filter circuit 302A is, for example, a low-pass filter, or integral filter, that attenuates the frequency component of the developing current or the non-developing current that is equal to or higher than the cutoff frequency. By including the filter circuit 302A, the current detection circuit 302 detects only the direct current.

The laser scanning device 35 irradiates each of the photoconductor drums 311, 321, 331, 341 of the four image forming units 31 to 34 with light, and forms an electrostatic latent image on the surface by lowering the potential of the irradiated exposed portion to be lower than the charge potential of the surrounding. In the present embodiment, the laser scanning device 35 includes two laser scanning units 351, 352. In response to the input of Y (yellow) image data, the laser scanning unit 351 irradiates the photoconductor drum 311 with light based on the image data to form an electrostatic latent image. In response to the input of C (cyan) image data, the laser scanning unit 351 irradiates the photoconductor drum 321 with light based on the image data to form an electrostatic latent image. In response to the input of M (magenta) image data, the laser scanning unit 352 irradiates the photoconductor drum 331 with light based on the image data to form an electrostatic latent image. In addition, in response to the input of K (black) image data, the laser scanning unit 352 irradiates the photoconductor drum 341 with light based on the image data to form an electrostatic latent image.

The toner images of the respective colors formed by the plurality of (here, four) image forming units 31 to 34 are transferred onto the outer peripheral surface of the intermediate transfer belt 361 in an overlapping manner. Thus, a color image (toner image) is formed on the outer peripheral surface of the intermediate transfer belt 361.

As shown in FIG. 3, the intermediate transfer device 36 includes an intermediate transfer belt 361, a drive roller 362, a tension roller 363, a belt cleaning portion 364, and a density detection portion 365. The intermediate transfer device 36 conveys the toner image formed by the image forming units 31 to 34 to the transfer position P1 (see FIG. 3) of the secondary transfer roller 37, using the intermediate transfer belt 361.

The intermediate transfer belt 361 is an endless belt to which toner images of respective colors are transferred from the photoconductor drums 311, 321, 331, 341. The intermediate transfer belt 361 is wound around the drive roller 362 and the tension roller 363 which are spaced apart from each other in the front-rear direction D2 of the image forming apparatus 10. The drive roller 362 rotates by receiving drive power supplied from a motor. Thus, the intermediate transfer belt 361 rotates in the rotational direction D4 shown in FIG. 3. The toner image transferred onto the outer peripheral surface of the intermediate transfer belt 361 is conveyed to the transfer position P1 of the secondary transfer roller 37 as the intermediate transfer belt 361 rotates. The belt cleaning portion 364 cleans the outer peripheral surface of the intermediate transfer belt 361 after the toner image is transferred at the transfer position P1.

The density detection portion 365 detects the density of the image (toner image) transferred onto the outer peripheral surface of the intermediate transfer belt 361. For example, the density detection portion 365 includes a reflective type optical sensor having a light emitting portion that emits light toward the outer peripheral surface of the intermediate transfer belt 361 and a light receiving portion that receives light emitted from the light emitting portion and reflected by the outer peripheral surface of the intermediate transfer belt 361. As shown in FIG. 3, the density detection portion 365 is disposed downstream of the image forming unit 34 and upstream of the secondary transfer roller 37 in the rotational direction D4 of the intermediate transfer belt 361. In addition, the density detection portion 365 is disposed to face one end of the outer peripheral surface of the intermediate transfer belt 361 in the width direction (left-right direction D3) of the intermediate transfer belt 361. The density detection portion 365 may be disposed to face both ends of the outer peripheral surface of the intermediate transfer belt 361 in the width direction of the intermediate transfer belt 361. The density detection portion 365 may detect the density of the toner image developed on the outer peripheral surface of the photoconductor drum 341.

The secondary transfer roller 37 transfers the toner image formed on the outer peripheral surface of the intermediate transfer belt 361 to a sheet supplied by the sheet feed portion 4. As shown in FIG. 3, the secondary transfer roller 37 is disposed in contact with the outer peripheral surface of the intermediate transfer belt 361 at a position facing the tension roller 363 with the intermediate transfer belt 361 interposed therebetween. The secondary transfer roller 37 is urged toward the tension roller 363 by an urging member. The secondary transfer roller 37 is electrically connected to a power supply circuit, and receives the application of a high voltage from the power supply circuit to transfer the toner image formed on the outer peripheral surface of the intermediate transfer belt 361 to a sheet passing through the transfer position P1 (see FIG. 3) at which the secondary transfer roller 37 and the intermediate transfer belt 361 come into contact with each other.

The length of the secondary transfer roller 37 in the axial direction (left-right direction D3) is shorter than the width of the intermediate transfer belt 361. Thus, on the outer peripheral surface of the intermediate transfer belt 361, a contact area that comes into contact with the secondary transfer roller 37 and a non-contact area (margin area) that does not come into contact with the secondary transfer roller 37 are formed. The non-contact area is both side areas outside the contact area on the outer peripheral surface of the intermediate transfer belt 361. The density detection portion 365 is disposed to face one of the non-contact areas. Of the image formed on the outer peripheral surface of the intermediate transfer belt 361, the secondary transfer roller 37 transfers the image formed in the contact area to the sheet, and does not transfer the image formed in the non-contact area to the sheet. The length of the secondary transfer roller 37 in the axial direction may be the same as the width of the intermediate transfer belt 361.

The fixing device 38 melts and fixes the toner image transferred to the sheet by the secondary transfer roller 37 to the sheet. For example, the fixing device 38 includes a fixing roller and a pressure roller. The fixing roller is disposed so as to be in contact with the pressure roller, and heats the toner image transferred to the sheet to fix it to the sheet. The pressure roller pressurizes the sheet passing through the contact area formed between the pressure roller and the fixing roller.

The sheet on which the image has been formed is discharged to the sheet discharge tray 39.

By the way, in an electrophotographic image forming apparatus, the developing property of the toner may deteriorate as the temperature inside the apparatus increases. Specifically, as the temperature inside the apparatus increases, the surface of the toner softens, an external additive or the like used as a fluidizing agent becomes embedded in the toner, reducing the fluidity of the toner, increasing the adhesive force of the toner to the carrier, making it difficult for the toner to separate from the carrier, and reducing the amount of toner transferred to the photoconductor drum, which results in a decrease in the developing property. If the temperature in the apparatus is detected and the image forming operation is stopped and the cooling operation is performed when the temperature exceeds the predetermined temperature in order to prevent the decrease in the developing property, the image forming operation is frequently stopped in some cases, and the convenience of the user is impaired. Further, even if the temperature inside the apparatus exceeds a predetermined temperature, softening of the toner due to the influence of the temperature does not necessarily occur, in which case, the image forming operation is stopped even though the developing property has not decreased, resulting in reduced productivity of the image forming apparatus.

On the other hand, in the image forming apparatus 10 according to the present embodiment, the configuration described below makes it possible to improve both the developing property and productivity of the image forming apparatus 10 as compared with the related art, without decreasing the developing property and without decreasing the productivity of the image forming apparatus 10.

That is, as shown in FIG. 1, the image forming apparatus 10 according to the present embodiment includes image forming units 31 to 34, a current detection circuit 302 provided in each of the image forming units 31 to 34, a temperature sensor 8, a calibration processing portion 51, a bias upper limit determination portion 53, a current detection processing portion 54, and a cooling control portion 55.

In the present embodiment, for example, as will be described later, the calibration processing portion 51, the bias upper limit determination portion 53, the current detection processing portion 54, and the cooling control portion 55 are provided in the control portion 5 as functions of the control portion 5.

### [3] Configuration of Control Portion

Next, each functional portion included in the control portion 5 will be described in more detail below with reference to FIG. 1. The control portion 5 includes processing portions such as a calibration processing portion 51, a bias upper limit determination portion 53, a current detection processing portion 54, and a cooling control portion 55. That is, the image forming apparatus 10 includes these processing portions as functions of the control portion 5.

The calibration processing portion 51 performs DC calibration processing for adjusting the voltage value of the DC component Vdc of the developing bias VB. The calibration processing portion 51 executes the DC calibration processing when a predetermined adjustment execution condition is satisfied. The adjustment execution condition is, for example, that an initial operation performed after the main power of the image forming apparatus 10 is turned on has been performed, or that a predetermined number of printing processes (e.g., 1000 sheets) has been counted.

In the present embodiment, the calibration processing portion 51 determines a set value (set voltage value) of the DC component Vdc when the image forming processing is performed at a reference process speed that is initially set as a standard speed of a plurality of process speeds that the image forming portion 3 can take.

The DC calibration processing is processing for causing the image forming portion 3 to execute processing for forming a predetermined test toner image (an example of the measurement toner image of the present disclosure), and determining and setting a voltage value (set voltage value) of the DC component Vdc of the developing bias VB in the image forming portion 3 in accordance with the density of the test toner image.

For example, the calibration processing portion 51 causes each of the image forming units 31 to 34 to form the test toner image. Thus, the test toner images of the four colors are developed on the surfaces of the respective photoconductor drums, and then transferred to the intermediate transfer belt 361. For example, the test toner image includes a toner patch. The test toner image is formed, for example, in the non-contact area on the outer peripheral surface of the intermediate transfer belt 361. It is noted that the test toner image may be formed in the contact area of the intermediate transfer belt 361.

Further, the calibration processing portion 51 acquires the results of detecting the densities of the test toner images of the four colors by the density detection portion 365. Further, the calibration processing portion 51 corrects the current set value (current set value) as the DC component Vdc in accordance with the difference between each of the results of detecting the densities of the test toner images of the four colors and a predetermined target density. Specifically, when the density of the test toner image is smaller than the target density, the calibration processing portion 51 determines the set value of the DC component Vdc to be a voltage value (set voltage value) larger than the current set value by a value corresponding to the density difference. In addition, when the density of the test toner image is higher than the target density, the calibration processing portion 51 determines the set value of the DC component Vdc to be a voltage value (set voltage value) smaller than the current set value by a value corresponding to the density difference.

When the image forming apparatus 10 is a monochrome printer, the test toner image is formed on the photoconductor drum 341, and the density detection portion 365 detects the density of the test toner image on the photoconductor drum 341.

The bias upper limit determination portion 53 performs processing for determining an upper limit voltage value (allowable upper limit value) of an allowable range for the set value of the DC component Vdc of the developing bias VB (bias upper limit value determination processing). The bias upper limit determination portion 53 obtains the allowable upper limit value based on the set value of the DC component Vdc determined by the calibration processing portion 51, for example. For example, the bias upper limit determination portion 53 determines and sets the allowable upper limit value to a value obtained by adding a predetermined addition value to the set value of the DC component Vdc determined by the calibration processing portion 51.

Here, the bias upper limit determination portion 53 may calculate the first allowable upper limit value by further taking into account the environmental condition of the place where the image forming apparatus 10 is installed. In this case, the environmental condition is, for example, absolute humidity. Specifically, the bias upper limit determination portion 53 calculates the allowable upper limit value on the condition that the absolute humidity exceeds a predetermined threshold value (for example, 80%). Alternatively, when the absolute humidity greatly changes, for example, when a difference between the absolute humidity calculated last time and the absolute humidity calculated this time exceeds a predetermined threshold (for example, 30 degrees), the bias upper limit determination portion 53 calculates the allowable upper limit value. It is noted that the ambient temperature of the image forming apparatus 10 may be used as the environmental condition.

The current detection processing portion 54 may detect, for example, the developing current (an example of the target current of the present disclosure) that flows when the first electric field for moving the toner from the developing roller toward the exposed portion of the photoconductor drum is formed in the opposing area where the two-component developer exists.

When the first electric field is formed, the current detection processing portion 54 acquires the current value detected by the current detection circuit 302 as the value of the developing current. Specifically, when the calibration processing portion 51 performs the DC calibration processing, the current detection processing portion 54 detects the developing current that flows when the first electric field is applied and the test toner image is developed.

As described above, the developing current includes a current that flows from the developing roller toward the exposed portion through the magnetic brush in the opposing area by the action of the first electric field formed in the opposing area. For example, when the toner is softened by heat and the external additive contained in the two-component developer is embedded in the toner, the fluidity of the toner decreases, and the toner becomes difficult to move away from the carrier. That is, the developing current becomes small.

On the other hand, when the toner contained in the magnetic brush in the opposing area is not softened by heat, the external additive contained in the two-component developer is not embedded in the toner, and the fluidity of the toner does not decrease, so that the toner easily moves away from the carrier. In other words, the developing current becomes large.

As another specific example, the current detection processing portion 54 detects the non-developing current (an example of the target current of the present disclosure) that flows when the second electric field for moving the toner from the non-exposed portion of the photoconductor drum toward the developing roller is formed in the opposing area where the two-component developer exists. In this case, when the second electric field is formed, the current detection processing portion 54 acquires the current value detected by the current detection circuit 302 as the value of the non-developing current.

As described above, the non-developing current includes a current that flows from the non-exposed portion toward the developing roller in the magnetic brush in the opposing area due to the action of the second electric field formed in the opposing area. For example, when the toner is softened by heat and the external additive contained in the two-component developer is embedded in the toner, the fluidity of the toner decreases, and the toner becomes difficult to move away from the carrier. That is, the non-developing current becomes small.

On the other hand, when the toner contained in the magnetic brush in the opposing area is not softened by heat, the external additive contained in the two-component developer is not embedded in the toner, and the fluidity of the toner does not decrease, so that the toner easily moves away from the carrier. In other words, the non-developing current becomes large.

In the present embodiment, when continuous print processing for forming an image on each of the continuously conveyed sheets is executed, the current detection processing portion 54 detects the non-developing current each time the developing roller faces the inter-sheet area of the photoconductor drum corresponding to the space between two consecutive sheets in the conveyance order.

The current detection processing portion 54 detects the non-developing current for each of the image forming units 31 to 34.

It is noted that the current detection processing portion 54 may detect the non-developing current at an arbitrary timing when the second electric field is formed in the opposing area during the execution of the continuous print processing. For example, the current detection processing portion 54 may detect the non-developing current at a timing when the non-developing area corresponding to a non-printing area such as a margin area included in the image data to be printed faces the developing roller.

In addition, the current detection processing portion 54 may detect the non-developing current at an arbitrary timing when the second electric field is formed in the opposing area during the execution of non-continuous print processing for forming an image on one sheet.

In addition, the current detection processing portion 54 may detect the non-developing current at an arbitrary timing when the second electric field is formed in the opposing area where the two-component developer exists during the image forming operation of the image forming apparatus 10.

The cooling control portion 55 executes a predetermined cooling operation based on the detected current detected by the current detection processing portion 54 and the detected temperature detected by the temperature sensor 8.

The cooling operation is, for example, any one or more of driving the cooling fan 9, decreasing the process speed of the image forming portion 3, and stopping the image forming operation of the image forming portion 3. Either operation can reduce the temperature inside the image forming apparatus 10.

In the present embodiment, the cooling control portion 55 executes the cooling operation, for example, when an absolute value of a current difference ΔI between the detected current and a predetermined reference current value exceeds a predetermined first threshold value and the detected temperature exceeds a predetermined second threshold value. It is noted that the reference current value, the first threshold value, and the second threshold value are design elements set to arbitrary values for the developing current or the non-developing current.

As another embodiment of the cooling control portion 55, for example, the cooling operation may be executed based on the set voltage value set by the calibration processing portion 51 and the detected temperature detected by the temperature sensor 8.

Specifically, the cooling control portion 55 may perform the cooling operation, for example, when an absolute value of a voltage difference AV between the set voltage value set by the calibration processing portion 51 and a predetermined reference voltage value exceeds a predetermined third threshold value and the detected temperature exceeds a predetermined second threshold value.

In another embodiment of the cooling control portion 55, for example, the cooling operation may be executed when the set voltage value set by the calibration processing portion 51 exceeds the allowable upper limit value determined by the bias upper limit determination portion 53 and the detected temperature exceeds a predetermined second threshold value.

### [4] Cooling Processing in Image Forming Apparatus (First Processing Example)

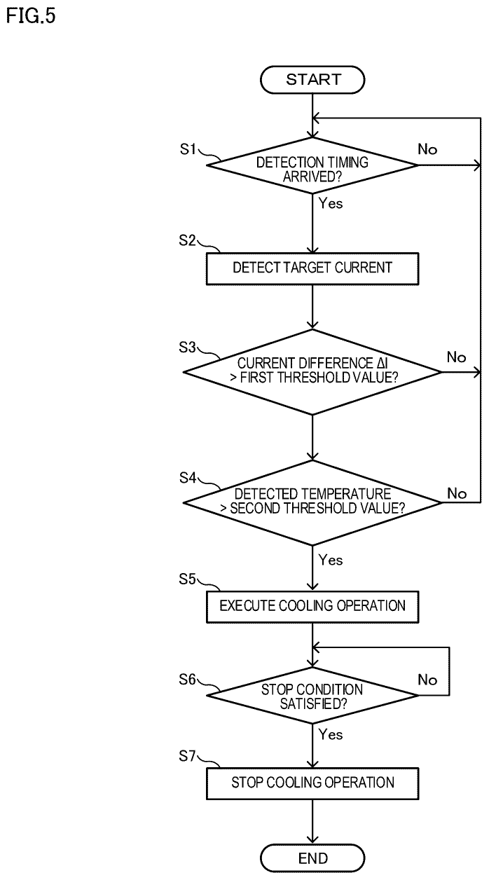

Hereinafter, a cooling method executed in the image forming apparatus 10 will be described with reference to the flowchart of FIG. 5, together with an example of a procedure of cooling processing (first processing example) executed by the control portion 5 in the image forming apparatus 10. Here, steps S1, S2, . . . represent the numbers of the processing procedure (steps) executed by the control portion 5.

### Step S1

First, in step S1, the control portion 5 determines whether or not a detection timing of the developing current or the non-developing current (hereinafter, referred to as a target current) has arrived.

Specifically, when the processing for developing the test toner image is performed during the DC calibration processing, the control portion 5 determines that the detection timing for detecting the developing current has arrived.

In addition, the control portion 5 determines that the detection timing for detecting the non-developing current has arrived when the developing roller faces the inter-sheet area of the photoconductor drum corresponding to the space between two consecutive sheets in the conveyance order during the execution of the continuous print processing.

Here, when the control portion 5 determines that the detection timing has arrived (Yes in S1), the control portion 5 shifts the processing to step S2. When the detection timing has not arrived (No in S1), the control portion 5 waits for the arrival of the detection timing in step S1.

### Step S2

In step S2, the control portion 5 detects the target current. Here, the process of step S2 is executed by the current detection processing portion 54 of the control portion 5.

### Step S3

When the target current is detected in step S2, in the next step S3, the control portion 5 calculates the absolute value of the current difference ΔI between the target current and the predetermined reference current value, and determines whether or not the absolute value of the current difference ΔI exceeds the predetermined first threshold value. Here, when the control portion 5 determines that the current difference ΔI exceeds the first threshold value, the control portion 5 shifts the processing to step S4. On the other hand, when the current difference ΔI does not exceed the first threshold value, the control portion 5 shifts the processing to step S1.

### Step S4

In step S4, the control portion 5 determines whether or not the detected temperature detected by the temperature sensor 8 exceeds a predetermined second threshold value. When the control portion 5 determines that the detected temperature exceeds the second threshold value, the control portion 5 shifts the processing to step S5. On the other hand, when the detected temperature does not exceed the second threshold value, the control portion 5 shifts the processing to step S1.

### Step S5

In step S5, the control portion 5 stops the operation of the image forming apparatus 10 so that the image forming operation cannot be executed, and then executes the cooling operation. During the execution of the cooling operation, even when a print instruction is input to the image forming apparatus 10, the image forming processing is not executed.

### Step S6

Thereafter, in step S6, the control portion 5 determines whether or not a stop condition for stopping the cooling operation is satisfied. The stop condition may be, for example, that the detected temperature detected by the temperature sensor 8 has fallen to a predetermined temperature lower than the second threshold value or that a predetermined time has elapsed.

### Step S7

When it is determined that the stop condition is satisfied, the control portion 5 stops the cooling operation and makes the image forming apparatus 10 ready to execute the image forming operation.

In this way, in the image forming apparatus 100, the cooling operation for cooling the inside of the image forming apparatus 10 is executed based on the detected current detected by the current detection processing portion 54 and the detected temperature detected by the temperature sensor 8. Specifically, the cooling operation is executed when an absolute value of a current difference ΔI between the target current (the developing current or the non-developing current) and a predetermined reference current value exceeds the first threshold value and the detected temperature exceeds the second threshold value. Thus, for example, even when the detected temperature exceeds the second threshold value, when the absolute value of the current difference ΔI does not exceed the first threshold value, the cooling operation is not executed, and the image forming apparatus 10 remains ready for image forming processing. As a result, the decrease in the developing property can be prevented in the image forming apparatus 10. In addition, since the cooling operation is executed when the absolute value of the current difference ΔI exceeds the first threshold value and the detected temperature exceeds the second threshold value, both of the developing property and the productivity can be improved as compared with the related art without decreasing the developing property and without decreasing the productivity of the image forming apparatus 10.

### [5] Cooling Processing in Image Forming Apparatus (Second Processing Example)

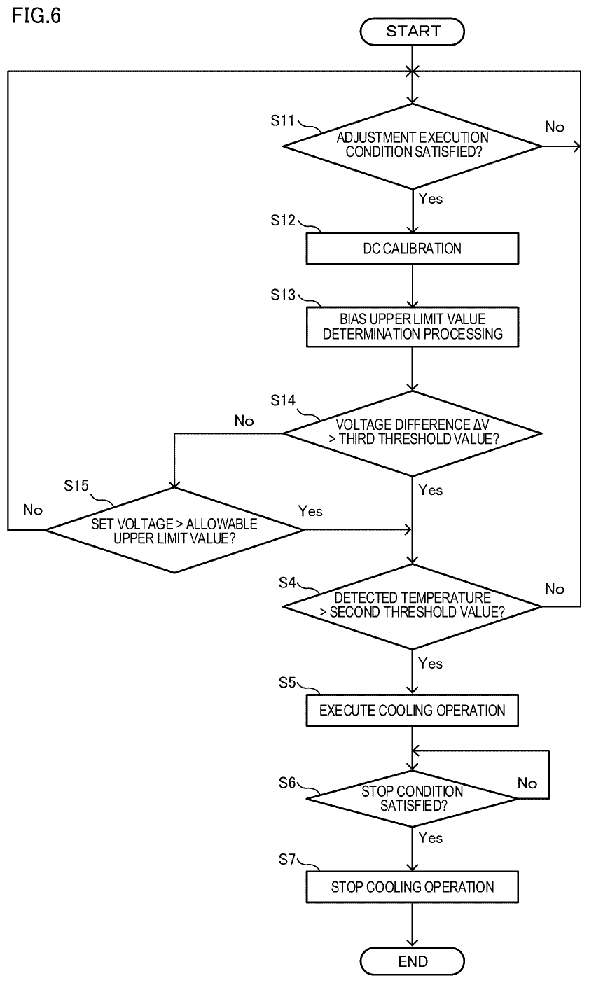

Hereinafter, a cooling method executed in the image forming apparatus 10 will Hereinafter, a cooling method executed in the image forming apparatus 10 will be described with reference to a flowchart of FIG. 6, together with an example of a procedure of cooling processing (first processing example) executed by the control portion 5 in the image forming apparatus 10. In the following description, only steps different from those of the first processing example shown in FIG. 5 will be described, and common steps will be denoted by the same reference numerals, and a detailed description thereof will be omitted.

### Step S11

In step S11, the control portion 5 determines whether or not the adjustment execution condition is satisfied.

### Step S12

When it is determined in step S11 that the adjustment execution condition is satisfied, the control portion 5 executes the DC calibration processing in step S12. The process of step S12 is executed by the calibration processing portion 51.

### Step S13

Upon completion of the process of step S12, in step S13, the control portion 5 executes the bias upper limit value determination processing for determining an upper limit voltage value (allowable upper limit value) of an allowable range for a set value of the DC component Vdc of the developing bias VB. The process of step S13 is executed by the bias upper limit determination portion 53. The allowable upper limit value determined in step S13 is stored in the storage portion 6.

### Step S14

In the next step S14, the control portion 5 calculates the absolute value of the voltage difference AV between the set voltage value set in the DC calibration processing and the reference voltage value, and determines whether or not the absolute value of the voltage difference AV exceeds the predetermined third threshold value. Here, when the control portion 5 determines that the voltage difference AV exceeds the third threshold value, the control portion 5 shifts the processing to step S4. On the other hand, when the voltage difference AV does not exceed the third threshold value, the control portion 5 shifts the processing to step S15.

### Step S15

In step S15, the control portion 5 determines whether or not the set voltage value set in the DC calibration processing exceeds the allowable upper limit value. Here, when the control portion 5 determines that the set voltage value exceeds the allowable upper limit value, the control portion 5 shifts the processing to step S4. On the other hand, when the set voltage value does not exceed the allowable upper limit value, the control portion 5 shifts the processing to step S11.

In this way, in the image forming apparatus 100, the cooling operation for cooling the inside of the image forming apparatus 10 is executed based on the set voltage value set by the calibration processing portion 51 and the detected temperature detected by the temperature sensor 8. Specifically, the cooling operation is executed when the absolute value of the voltage difference AV between the set voltage value and the predetermined reference voltage value exceeds the third threshold value and the detected temperature exceeds the second threshold value. Even when such cooling processing is executed, both of the developing property and the productivity can be improved as compared with the prior art without decreasing the developing property and the productivity of the image forming apparatus 10.

In addition, when the set voltage value exceeds the allowable upper limit value and the detected temperature exceeds the second threshold value, the cooling operation is executed. Even when such cooling processing is executed, both of the developing property and the productivity can be improved as compared with the prior art without decreasing the developing property and the productivity of the image forming apparatus 10.

It is noted that, in the second processing example of the cooling processing shown in FIG. 6, both of the determination processes of step S14 and step S15 do not have to be executed, and at least one of the determination processes may be executed. Of course, by executing both the determination processes of step S14 and step S15, it is possible to further improve the developing property and the productivity in the image forming apparatus 10.

### APPENDIXES OF INVENTION

The following are appendixes to the overview of the invention extracted from the above embodiment. It is noted that the structures and processing functions to be described in the following appendixes can be selected and combined arbitrarily.

### Appendix 1

An image forming apparatus comprising:
an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier;
a current detection portion configured to detect a target current that flows between the first carrier and the second carrier during development;
a temperature detection portion configured to detect a temperature inside the apparatus; and
a cooling control portion configured to execute a predetermined cooling operation based on a detected current that is detected by the current detection portion and a detected temperature that is detected by the temperature detection portion.

### Appendix 2

The image forming apparatus according to Appendix 1, wherein the cooling control portion executes the cooling operation when a current difference between the detected current and a predetermined reference current value exceeds a predetermined first threshold value and the detected temperature exceeds a predetermined second threshold value.

### Appendix 3

The image forming apparatus according to Appendix 1 or 2, wherein
the target current is a developing current that flows from the second carrier to the developing area of the first carrier during development, and
the current detection portion detects the developing current flowing from the second carrier to the developing area of the first carrier during development of a predetermined measurement toner image formed on the first carrier when calibration processing for setting a set voltage value of the bias voltage is executed.

### Appendix 4

The image forming apparatus according to any one of Appendixes 1 to 3, wherein
the target current is a non-developing current that flows from a non-developing area of the first carrier to the second carrier when the bias voltage is applied, and
the current detection portion detects the non-developing current at a timing at which an inter-sheet area corresponding to a space between two consecutive sheets in conveyance order on the first carrier faces the second carrier when continuous print processing for forming an image on each of sheets continuously conveyed is executed.

### Appendix 5

An image forming apparatus comprising:
an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier;
a calibration processing portion configured to execute calibration processing for setting a set voltage value of the bias voltage;
a temperature detection portion configured to detect a temperature inside the apparatus; and
a cooling control portion configured to execute a predetermined cooling operation based on the set voltage value determined by the calibration processing portion and a detected temperature that is detected by the temperature detection portion.

### Appendix 6

The image forming apparatus according to Appendix 5, wherein the cooling control portion executes the cooling operation when a voltage difference between the set voltage value and a predetermined reference voltage value exceeds a predetermined third threshold value and the detected temperature exceeds a predetermined second threshold value.

### Appendix 7

The image forming apparatus according to Appendix 5 or 6, wherein the cooling control portion executes the cooling operation when the set voltage value exceeds a predetermined upper limit voltage value for the bias voltage and the detected temperature exceeds a predetermined second threshold value.

### Appendix 8

The image forming apparatus according to any one of Appendixes 1 to 7, wherein the cooling control portion executes one or more of driving a cooling fan, decreasing a process speed of the image forming portion, and stopping an image forming operation of the image forming portion as the cooling operation.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier;
a current detection portion configured to detect a target current that flows between the first carrier and the second carrier during development;
a temperature detection portion configured to detect a temperature inside the apparatus; and
a cooling control portion configured to execute a predetermined cooling operation based on a detected current that is detected by the current detection portion and a detected temperature that is detected by the temperature detection portion.

2. The image forming apparatus according to claim 1, wherein the cooling control portion executes the cooling operation when a current difference between the detected current and a predetermined reference current value exceeds a predetermined first threshold value and the detected temperature exceeds a predetermined second threshold value.

3. The image forming apparatus according to claim 1, wherein
the target current is a developing current that flows from the second carrier to the developing area of the first carrier during development, and
the current detection portion detects the developing current flowing from the second carrier to the developing area of the first carrier during development of a predetermined measurement toner image formed on the first carrier when calibration processing for setting a set voltage value of the bias voltage is executed.

4. The image forming apparatus according to claim 1, wherein
the target current is a non-developing current that flows from a non-developing area of the first carrier to the second carrier when the bias voltage is applied, and
the current detection portion detects the non-developing current at a timing at which an inter-sheet area corresponding to a space between two consecutive sheets in conveyance order on the first carrier faces the second carrier when continuous print processing for forming an image on each of sheets continuously conveyed is executed.

5. An image forming apparatus comprising:
an image forming portion configured to apply a bias voltage between a first carrier with a surface to be charged and a second carrier configured to hold toner to be adhered to the first carrier to move the toner from the second carrier to a developing area of the first carrier to develop the developing area of the first carrier;
a calibration processing portion configured to execute calibration processing for setting a set voltage value of the bias voltage;
a temperature detection portion configured to detect a temperature inside the apparatus; and
a cooling control portion configured to execute a predetermined cooling operation based on the set voltage value determined by the calibration processing portion and a detected temperature that is detected by the temperature detection portion.

6. The image forming apparatus according to claim 5, wherein the cooling control portion executes the cooling operation when a voltage difference between the set voltage value and a predetermined reference voltage value exceeds a predetermined third threshold value and the detected temperature exceeds a predetermined second threshold value.

7. The image forming apparatus according to claim 5, wherein the cooling control portion executes the cooling operation when the set voltage value exceeds a predetermined upper limit voltage value for the bias voltage and the detected temperature exceeds a predetermined second threshold value.

8. The image forming apparatus according to claim 1, wherein the cooling control portion executes one or more of driving a cooling fan, decreasing a process speed of the image forming portion, and stopping an image forming operation of the image forming portion as the cooling operation.
